(19) United States
(12) Patent Application Publication
(10) Pub. No.: US 2013/0268578 A1
(43) Pub. Date: Oct. 10, 2013

(54) Method And Apparatus For Facilitating Communications With A Managed Client Device

(71) Applicants: Arabinda Bose, Cedar Park, TX (US); Gordon McKinney, Cedar Park, TX (US); Vinod Nair, Austin, TX (US); Bahadir Danisik, Antwerpen (BE); Filip Humble, Mol (BE); Robert Steven Farnum, Austin, TX (US); Scott Pelley, Austin, TX (US)

(72) Inventors: Arabinda Bose, Cedar Park, TX (US); Gordon McKinney, Cedar Park, TX (US); Vinod Nair, Austin, TX (US); Bahadir Danisik, Antwerpen (BE); Filip Humble, Mol (BE); Robert Steven Farnum, Austin, TX (US); Scott Pelley, Austin, TX (US)

(21) Appl. No.: 13/728,298

(22) Filed: Dec. 27, 2012

Related U.S. Application Data
(60) Provisional application No. 61/622,156, filed on Apr. 10, 2012.

(51) Int. Cl. H04L 29/06

(52) U.S. Cl. CPC H04L 65/1069
USPC 709/203

(57) ABSTRACT

A method and apparatus for facilitating communications between a managing server and a client device. The managing server may be an ACS operable to configure a CPE to received connection request from an external server, which thereby brokers initiation of a communication session between the CPE and the ACS. The external server also preferably determines what type of connection request to use and provides configuration parameters to the ACS.

### CROSS-REFERENCE TO RELATED APPLICATIONS

The present disclosure is related to and claims priority from U.S. Provisional Patent Application Ser. No. 61/622,156, entitled XMPP Keepalive Interval Program and filed on 20 Jun. 2012, the entire contents of which are incorporated by reference herein.

### TECHNICAL FIELD

The present invention relates generally to the field of communication networks and, more particularly, to a method and apparatus for communicating with managed client devices via a communication network.

### BACKGROUND

The following abbreviations are herewith defined, at least some of which are referred to within the following description of the state-of-the-art and the present invention.

### ACS Auto Configuration Server

### BBF Broad Band Forum

### CPE Customer Premises Equipment

### CR Connection Request

### GPV Get Parameter Value

### LAN Local Area Network

### HTML Hyper Text Markup Language

### OSS Operations Support System

### PII Periodic Inform Interval

### RPC Remote Procedure Call

### SMS Short Message Service

### SPV Set Parameter Value

TR Technical Report [a BBF term]

### XMPP Extensible Messaging and Presence Protocol

Computers, telephones, and other devices may be connected together to form networks. The devices in a network can communicate with each other and share computing resources. Homes and businesses, for example, may have LAN (local area network) computer networks in place. Larger networks are maintained by the telephone company and other carriers for allowing subscribers to communicate across great distances. Gateways or similar devices connect one network to another allowing for communication between users of devices on one network and users of devices on another. The global communication network known as the Internet is actually made up of a great many networks in communication with each other.

Computers and other devices in a network can not only communicate with each other, but can share computing resources and data. A server is a device that permits client devices to contact it for this purpose. The user of a personal computer may, for example, contact a remote server to download a Web page or order items from on on-line catalog. Email servers receive emails from one user and send them to another, or to another email server. Pictures and music may be stored in a distant memory storage device by a user contacting a server configured for this purpose.

At times it is desirable to manage certain devices, such as the router in a home LAN, from a remote server. This type of managed device is often referred to as a CPE (customer premises equipment). A device that is capable if remotely managing CPE devices associated with a communications network may be generically referred to as an ACS (auto-configuration server). CPE devices joining the network register with the ACS and often periodically send to it messages indicating their status. One standard protocol dealing with the communication between an ACS and a CPE is Broadband Forum's TR-069 protocol.

A CPE typically may contact an ACS at any time so long as the address of the ACS is known to or discoverable by the CPE. A gateway allows the transmission from the CPE and any response from the ACS while the communication session between them is active. After a certain period of time, however, the incoming port necessary for the ACS to send communications to the CPE is closed. In many private networks a NAT (network address translation) boundary exists and there is no direct way for the ACS to directly contact the CPE outside of a CPE-initiated communication session. A manner of getting the CPE to initiate such contact is through a connection request. The connection request is sent by the ACS using an address supplied by the CPE at registration (or at a later time) to do so.

Unfortunately, there are a great many types of CPE devices to be managed, and they may use a wide variety of protocols, for example XMPP or SMS and others that are yet to be defined. It would be desirable to decouple the ACS from having to maintain direct knowledge of each of these protocols so that it may send connection request type messages to this wide array of devices. These needs and other needs are addressed by the present invention.

Note that the techniques or schemes described herein as existing or possible are presented as background for the present invention, but no admission is made thereby that these techniques and schemes were heretofore commercialized or known to others besides the inventors.

### SUMMARY

The present invention is directed to a manner of facilitating communications between a managing server and a client device. In one aspect, the present invention is a method for facilitating communication between a managing server and a managed client device including receiving at an external server a notification from an ACS (auto configuration server) having the ID (identification) of a managed client device and determining at least one type of connection request message for sending a connection request to the client device. The notification from the ACS may include data model parameters associated with the client device. In some embodiments, the parameters may have been received from an OSS (operations support system). The method may further include sending the determined type of connection request to the client device and, if so, also include sending a response to the ACS indicating whether the connection request has been successfully sent.

In some embodiments, this aspect of the invention may also include determining at least one type of connection request comprises referring to a device database associated with the external server. The method may further include determining by the external server configuration parameters for configuring the client device and sending the configuration parameters to the ACS. The method may further include configuring the client device during a communication session between the ACS and the client device. The method may also include determining by the ACS that the client device connection request parameters are not configured prior to sending the notification to the external server from the ACS.

In another aspect, the present invention is an external server for facilitating communications between a managing server and a managed client device including a processor, a memory device in communication with the processor, and a connection request type selection module for selecting a connection request type for associating with a client device. The external server may also include one or more of an ACS configuration module for provisioning an ACS with parameters associated with a selected connection request type, a CPE (customer premises device) type database on the memory device for storing available types of connection requests, or a CPE parameters database for storing the parameters associated with an available connection request type. The external server preferably includes program instructions stored on the memory device that when executed send a connection request to the client device.

In yet another embodiment, the present invention is an ACS for facilitating communications between a managing server and a managed client device that includes a processor, a memory device in communication with the processor embodying program instructions that when executed cause the ACS to send a message to an external server requesting that the external server broker initiating a communication session between the ACS and a client device identified in the message. The ACS may further include program instructions that when executed cause the ACS to send a message to an external server to request configuration parameters for configuring the client device to respond to a connection request from the external server. In a preferred embodiment, the ACS further includes a CPE configuration module for configuring a client device with parameters received from the external server and associated with the client device.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be obtained by reference to the following detailed description when taken in conjunction with the accompanying drawings wherein:

FIG. 1 is a simplified schematic diagram illustrating selected components of a typical communication network;

FIG. 2 is a simplified schematic diagram illustrating selected components of the communication network of FIG. 1 configured according to an embodiment of the present invention;

FIG. 3 is a sequence diagram illustrating a message flow according to an embodiment of the present invention;

FIG. 4 is a sequence diagram illustrating a message flow according to another embodiment of the present invention;

FIG. 5 is a sequence diagram illustrating a message flow 350 according to another embodiment of the present invention;

FIG. 6 is a simplified block diagram illustrating selected components of an ACS according to an embodiment of the present invention;

FIG. 7 is a simplified block diagram illustrating selected components of an external server according to an embodiment of the present invention;

FIG. 8 is a flow diagram illustrating a method 500 according to an embodiment of the present invention; and

FIG. 9 is a flow diagram illustrating a method 600 according to an embodiment of the present invention.

### DETAILED DESCRIPTION

The present invention is directed at a manner of communicating with a managed client device via a communication network. As alluded to above, an environment in which the present invention may be particularly advantageous involves an ACS (auto configuration server) that communicates with a great number of managed devices such as those found in a home or business enterprise, where they are often part of a LAN (local area network) associated with that home or business. In this environment, there is often (though not necessarily) a NAT (network address translation) boundary that makes it often difficult to address management communications to the device directly, unless it is in response to a very recent communication from the device to the ACS.

From time to time, the managed device sends an inform message to the ACS to alert the ACS to a problem or simply to report the absence of a problem during regular operation. At other times, the ACS may send a connection request addressed to the managed device in an attempt to provoke the device into sending an inform message and initiating a communication session so that the ACS may request or download information, install upgrades, or perform other functions for which communication with the managed device is required. Note that as used herein, the terms “inform message” and “connection request” are meant generically, though in most implementations they will be messages sent pursuant to Broadband Forum's TR-069 protocol (or a related or successor protocol). Note also that “ACS” and “managed device” or “managed client device” will refer to any devices that must communicate in similar fashion regardless of whether they are commonly referred to by those terms.

As also mentioned above, the number and types of managed devices with which an ACS must communicate may vary widely. The same is true for the mechanisms by which the managed client devices can or must communicate. Even the same network subscriber, home, or business, may from time to time change the devices that they use from time to time. This gives rise to a logistical obstacle for the ACS, which is often not equipped to deal with these relatively rapidly changing conditions while still performing the tasks for which it is responsible.

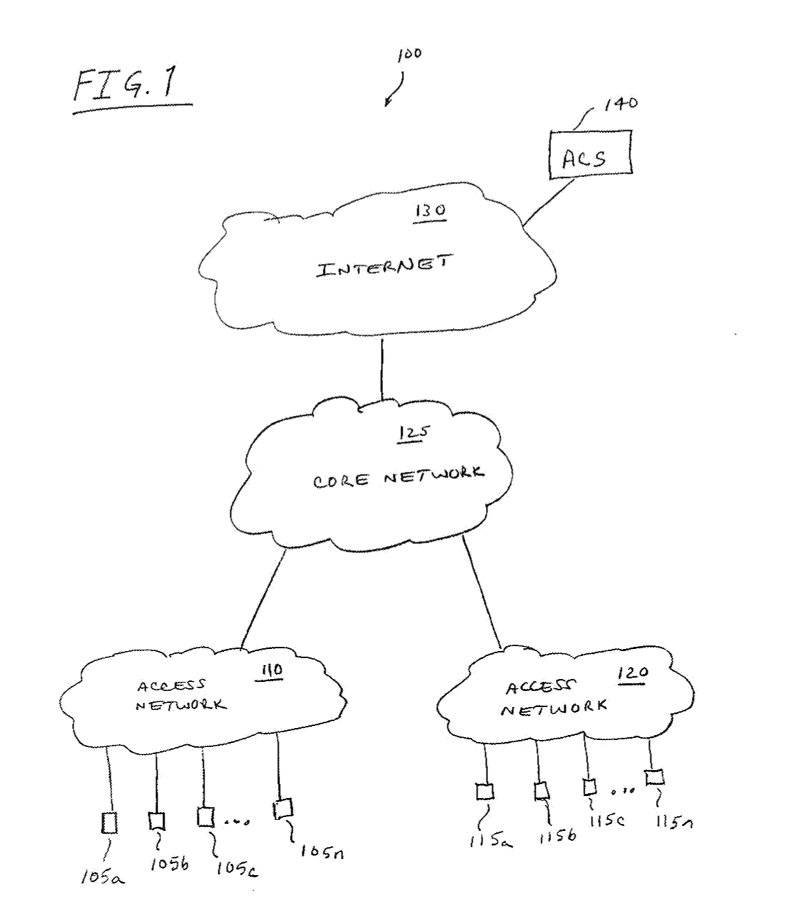

FIG. 1 is a simplified schematic diagram illustrating selected components of a typical communication network 100. In this example network 100 depicts CPE (customer premises equipment) devices 105a through 105n and 115a through 115n. As implied by the ellipses, there may be any number of CPEs, and of course the number connected to any particular access network may vary over time. These CPEs may be connected to home or business networks, but this is not shown in FIG. 1. The term “CPE” as used herein is the equivalent of “managed device” or “managed client device”, and is intended to be interpreted to broadly describe all devices that are or can be managed according to the principles described herein.

The CPEs are shown in FIG. 1 to be connected to respective access networks, represented by clouds 110 and 120; CPEs 105a though 105n are connected to access network 110, and CPEs 115a through 115n are connected to access network 120. The connection between a given CPE and its respective access network is frequently a wireline connection such as a telephone line, optic fiber, or coaxial cable. This is not a requirement, however, and other forms of access including a wireless channel may be used. Though only two access networks are shown, there may be others or only one in a given implementation.

The access networks 110 and 120 shown in FIG. 1 connect the individual CPE devices to a core network 125. Core network 125 is a high capacity network interconnecting many devices and providing connections to other networks, such as the Internet 130. Note that each of the access networks 110 and 120, the core network 125, and Internet 130, represented by respective clouds in FIG. 1, are in reality made up of a number of switching and routing components and connect to each other via gateways, which for simplicity are not separately shown in FIG. 1.

In the exemplary embodiment of FIG. 1, an ACS 140 is in communication with the Internet 130 and therefore able to communicate with each of the CPEs 105a through 105n and 115a through 115n, assuming a mutually acceptable protocol is available to do so. Some of the difficulties associated with communication by the ACS to each of the CPEs have been outlined above. A manner of addressing these and other difficulties is presented by the embodiments described below.

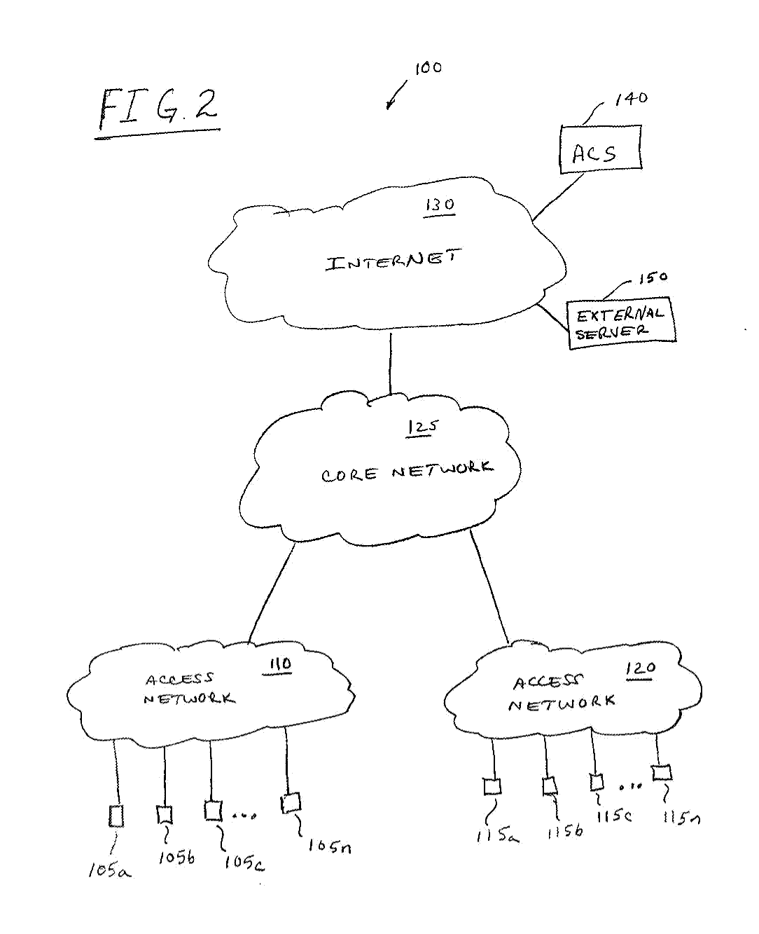

FIG. 2 is a simplified schematic diagram illustrating selected components of communication network 100 configured according to an embodiment of the present invention. As should be apparent, the network 100 has been enhanced by the addition of an external server 150, configured according to the present invention as will be described in more detail. In this embodiment, external server 150 is also connected with Internet 130, and so is able to communicate with ACS 140 and each of the individual CPEs. In other embodiments (not shown), this could be achieved by connecting external server 150 to the core network 125 or directly to ACS 140. In some instances, external server 150 may be housed in the same physical location as ACS 140, but this is not a requirement. It is preferred, however, that external server 150 and ACS 140 are separated sufficiently so as not to draw on each other's computing resources and to function truly independently. External server 150 may in fact serve more than one ACS, though in other implementations an ACS may have access to the services provided by more than one external server. The function and configuration of the external server will now be described in more detail.

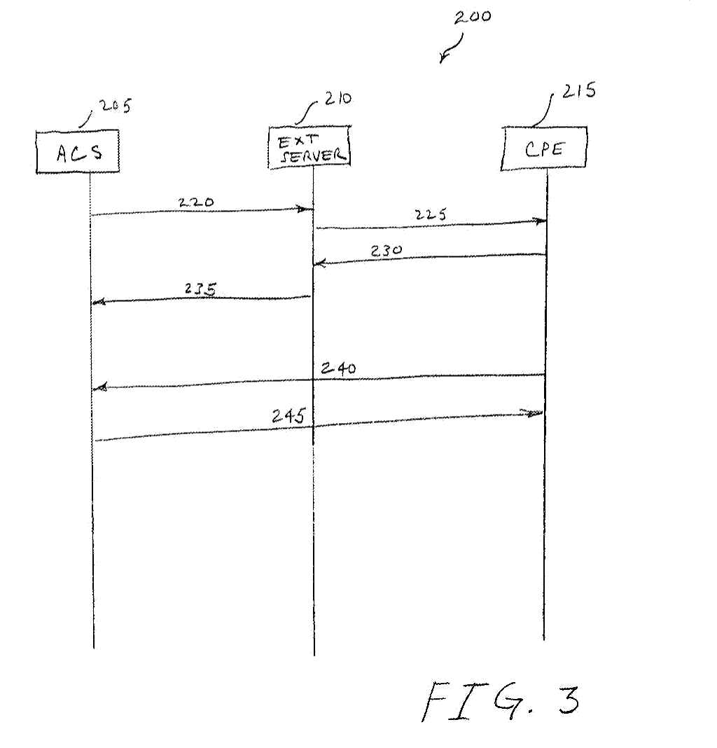

FIG. 3 is a sequence diagram illustrating a message 200 flow according to an embodiment of the present invention. The components shown are ACS 205, external server 210, and CPE 215. Note that while communication occurs between these three devices, it is not necessary that they are directly connected to each other. In this sequence it is presumed that the ACS 205 may be aware of the existence of the CPS 215 but is not necessarily aware of the mechanism to use for transmitting a connection request. Instead, the ACS 205 relies on an external server 210.

In the embodiment of FIG. 3, instead of attempting to contact the CPE 215 directly, the ACS 205 sends message 220 to the external server 210. In this embodiment message 220 may be referred to as a kickDevice message and take the form of an HTTP POST request. The kickDevice message 220 preferably contains an ID for CPE 215 and a URL through which it may be contacted. Data model parameters may also be included. Note that CPE 215 may support more than one connection request technology, and the information provided to external server 210 in message 220 may be used to select the most appropriate.

In this embodiment, the external server 210 then determines the type of connection request that may be used for contacting CPE 215 and, if more than one type of connection request is acceptable, then it determines which of the available types is most appropriate. In make in making this determination, external server 210 may simply select the first type of connection request determined or refer to a priority list that it has access to. More sophisticated determinations may be based on current network conditions or reported performance data. In some embodiments (not shown), the determination may be made repeatedly until a successful connection request is confirmed.

However the determination is made, in the embodiment of FIG. 3 the external server then sends a message 225 to the CPE 215 using the determined technology. The message 225 may also be referred to as a kickDevice message, bearing in mind the purpose of provoking the CPE 215 to initiate a communication session involving ACS 205. In this embodiment, the CPE responds by sending message 230 to the external server. Message 230 preferably indicates the success or failure of the attempted communication. In some instances, of course, the failure to send and receive message 230 may also be interpreted as a failure by external server 210.

In the embodiment of FIG. 3, upon receiving the response message 230 or noting its failure to arrive the external server 210 send message 235 to the ACS 205. Message 235 is in this embodiment an HTTP POST response to the message 220 originally sent by the ACS 205. Message 235 indicates the success or failure by external server 210 to contact CPE 215.

Assuming a successful attempt, in this embodiment, the CPE 215 then sends an inform message 240 to the ACS 205, initiating the desired communication session (as represented by the ACS response message 245). Note that the CPE will in most cases already be aware of the address of the ACS 205, but in the event that it is not this could also be provided by the external server 210, either in message 225 or otherwise.

If the attempt by ACS 205 to initiate a communication session is not successful, it may retry or simply wait for an inform message from the CPE 215, for example in the event that the CPE re-boots or sends the inform message for another reason. Note also that in some implementations (note shown in FIG. 3) the ACS may attempt to send one or more connection requests to the CPE directly prior to messaging the external server (using message 220). That is, trying or even succeeding to initiate a communication session by the ACS does not preclude it from performing the processes of the present invention.

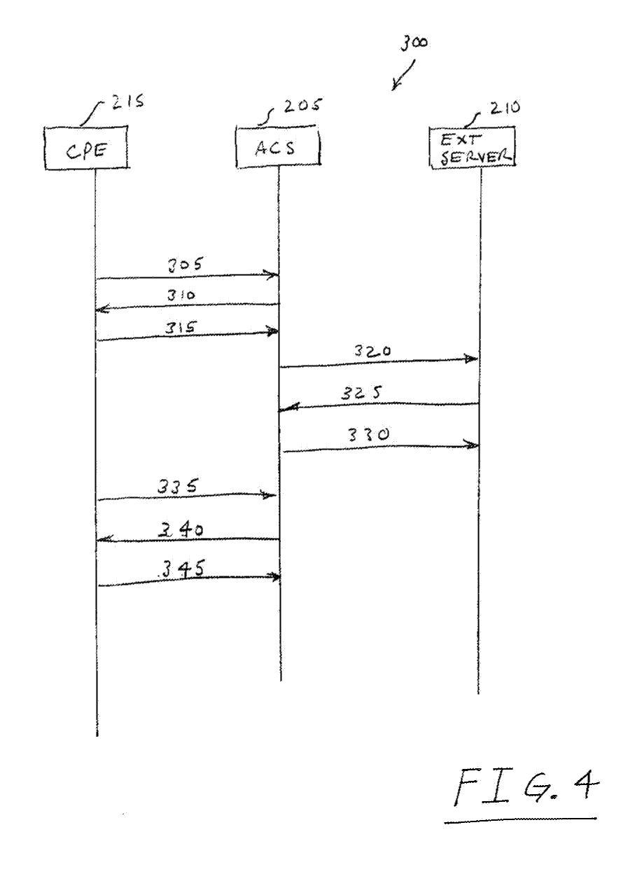

FIG. 4 is a sequence diagram illustrating a message 300 flow according to another embodiment of the present invention. As with the embodiment of FIG. 3, the components shown are ACS 205, external server 210, and CPE 215. Note again that while communication occurs between these three devices, it is not necessary that they are directly connected to each other. The sequence of FIG. 4 begins when an inform message 305 is received at ACS 205. Note that an inform message can be sent from the CPE 215 on its own initiative, and a communication session initiated, without the ability of the ACS 205 to prompt the sending of an inform message using a connection request.

For purposes if illustration, in the embodiment of FIG. 4 it is presumed that the connection request settings are not yet configured; the message sequence according to this embodiment is useful for generating and provisioning the settings. When ACS 205 receives the inform message 305, it checks the status of the connection request settings for CPE 215 and determines that they are not in place. In response, therefore, it sends message 310 which in this case is an RPC (remote procedure call) according to TR-069. The message 310 includes instructions to fetch parameters from the CPE 215, for example data model parameters. A TR-069 GetParameterValue instruction may be used for this purpose. This instruction is provided in an attempt to get information useful in determining the type of connection request required or at least most suitable for CPE 215.

In this embodiment, the ACS 205 also sends an instruction, for example a TR-069 SPV (set parameter value) instruction, so that the CPE 215 sends more frequent inform messages. This parameter may be referred to as a PII (periodic inform interval). An interval of, for example, five minutes is considered desirable in this context. In most embodiments, these instructions can be sent in any order. The CPE 215 returns the requested parameters in response message 315.

In the embodiment of FIG. 4, the ACS 205 then sends message 320 to external server 210. Message 320 then sends the ID of CPE 215 and the parameters associated with it to an external server 210. Message 320 is preferably an asynchronous notification. Upon receiving message 320, the external server 210 then determines the type of connection request needed for this CPE and stores the information relating to CPE 215 on a memory device associated with or available to external server 210. In this embodiment, the external server includes a listener that can generate credentials for the CPE if these credentials have not been provided by the ACS 205 already.

In this embodiment, external server 210 then sends message 325 to ACS 205. Message 325 includes the parameters needed to configure the connection request mechanism on CPE 215. Message 325 may be referred to as a setKickInfo message. The ACS 205 responds with message 330 indicating that the setKickInfo message has been received.

In this embodiment, this configuration is performed by ACS 205. Note that while the external server 210 has determined the appropriate type of connection request, this configuration may be required before such a connection request may be used to initiate a communication session. For this reason the ACS 205 will typically have to wait for the next inform message from CPE 215 before it can act. As the interval between inform messages was previously set low, the delay should not be great.

In the embodiment of FIG. 4, when the ACS 205 next receives an inform message 335 from the CPE 215, it sends a response message 340, which is this embodiment is an RPC (remote procedure call). With message 335 the ACS 205 executes an SPV (set parameter value) instruction according to the connection request type provided by the external server 210. In this embodiment, the ACS 205 itself determines the appropriate SPV for the CPE 215 based on this information. The ASC 205 also resets the inform message interval (here, the PII) to a longer interval, for example twenty-four hours. CPE 215 responds in message 345.

In this fashion connectability is established involving the CPE 215 and the external server 210. The external server will then be able to provoke CPE 115 to send an inform message to ACS 205 when necessary (see, for example, the sequence of FIG. 3).

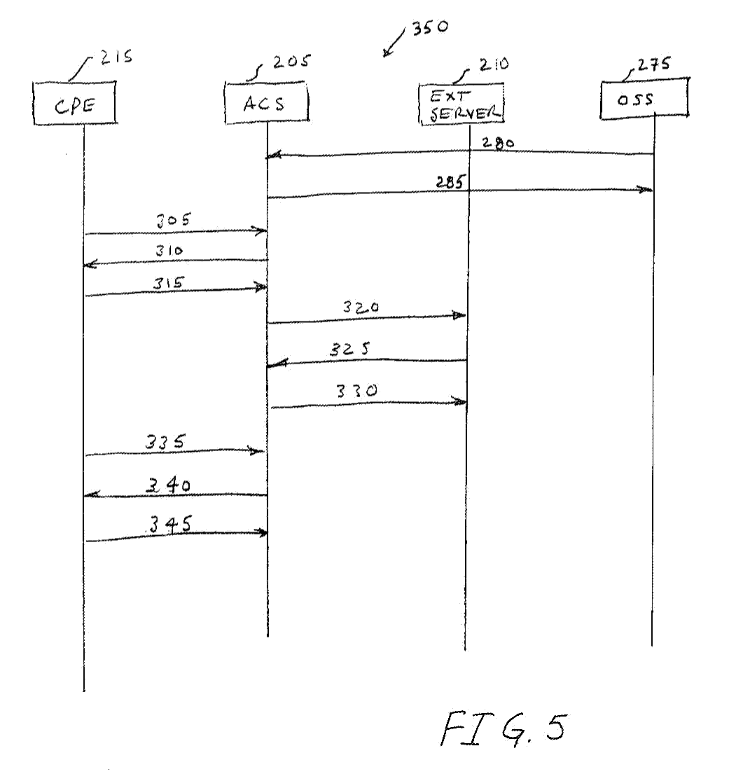

FIG. 5 is a sequence diagram illustrating a message flow 350 according to another embodiment of the present invention. As with the embodiments of FIGS. 3 and 4, the components shown are ACS 205, external server 210, and CPE 215. Also shown in FIG. 5 is OSS (operational support system) 275. In this embodiment, the connection request configuration and credentials are generated by the OSS. Note that while communication occurs between these three devices, it is not necessary that they are directly connected to each other. The sequence of FIG. 5 begins when message 280 from OSS 275 is received at ACS 205.

In the embodiment of FIG. 5, with message 280, the OSS provisions connection-request-related parameters on the ACS 205. ACS responds in message 285. As should be apparent, the remainder of the sequence 350 is similar or identical to the sequence 300 illustrated in FIG. 4 and described above. In this embodiment, however, the ACS 205 in message 320 transmits to the external server 210 the parameters provided to the ACS 205 by OSS 275 in message 280. External server then needs only to generate the missing parameters, if any.

In this fashion connectability is established involving the CPE 215 and the external server 210 using parameters or credentials, or both, provided by the OSS 275. The external server will then be able to provoke CPE 115 to send an inform message to ACS 205 when necessary (see, for example, the sequence of FIG. 3).

Note that the representations of FIGS. 3 through 5 are exemplary embodiments and some variation is possible. Note also that each message may be representative of a number of messages that are necessary to accomplish the desired effect. In some cases, messages show separately in FIGS. 3 through 5 may be combined. Note that the messages may be sent in any logically-consistent order.

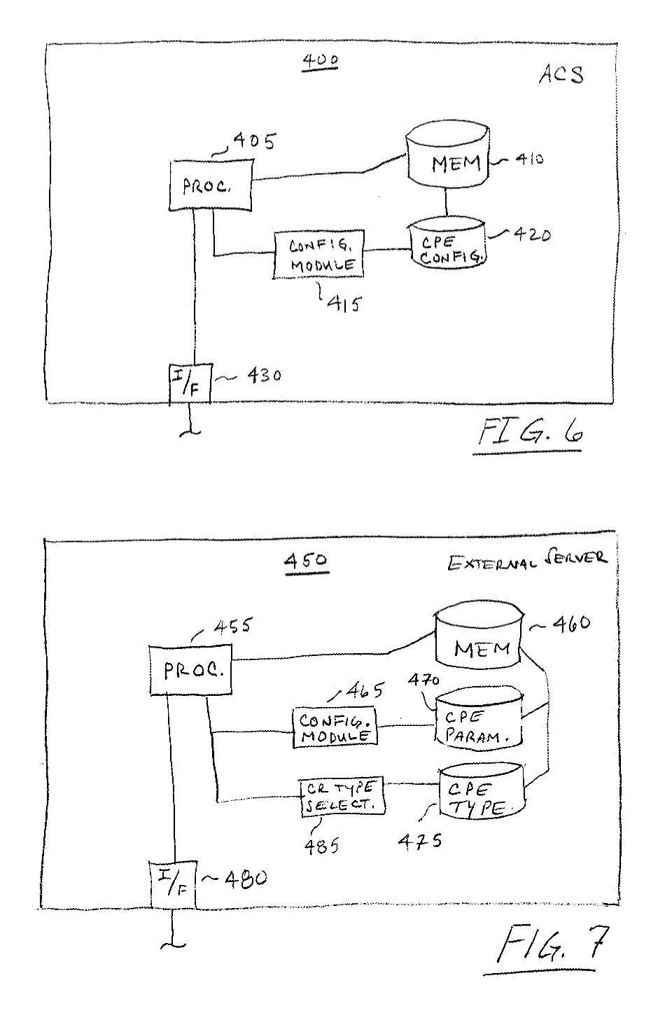

FIG. 6 is a simplified block diagram illustrating selected components of an ACS 400 according to an embodiment of the present invention. ACS 400 is implemented in hardware or by software executing on a physical hardware device or a combination of both. Depicted in this embodiment are a processor 405 and an associated memory device 410. Memory device 410 is a physical device for storing data and program instructions, including program instruction for executing memory-related functions. Unless explicitly stated to the contrary in a particular embodiment, memory device 410 is non-transitory in the sense of not consisting solely of an electronic signal.

In the embodiment of FIG. 6, the ACS 400 includes a processor 405 for controlling operation of various server components and executing program instructions stored on the memory device 410. Processor 405 and memory device 410 are implemented in physical devices, or physical devices executing stored program instructions. Memory device 410 is non-transitory in the sense of not consisting solely of a propagating signal.

In this embodiment, ACS also includes a CPE configuration module 415 for configuring client devices according to parameters provided by an external server (not shown in FIG. 6). CPE configuration module 415 may be implemented in hardware, such as an ASIC, or as program instructions stored in memory device 410 and executed by processor 405. A CPE configuration database 420 is also shown. The CPE configuration database may be stored, for example, in memory device 410. In a preferred embodiment, the CPE database stored configuration parameters associated with client devices, along with their configuration status. Finally, network interface 430 is present to allow the ACS 400 to communicate via a communications network such as the Internet (see, for example, FIG. 2).

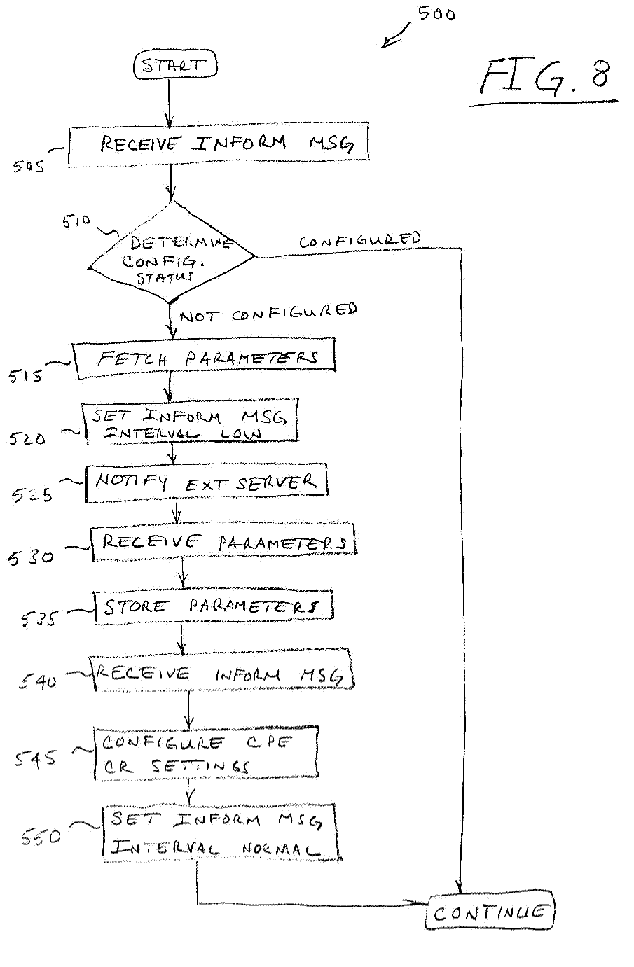

FIG. 7 is a simplified block diagram illustrating selected components of an external server 450 according to an embodiment of the present invention. External server 450 is implemented in hardware or by software executing on a physical hardware device or a combination of both. Depicted in this embodiment are a processor 455 and an associated memory device 460. Processor 455 and memory device 460 are implemented in physical devices, or physical devices executing stored program instructions. Memory device 460 is non-transitory in the sense of not consisting solely of a propagating signal.

In this embodiment, external server 450 also includes an ACS configuration module 465 for provisioning an ACS (not shown in FIG. 7) with the parameters necessary to configure a given client device and a connection request type selection module 485 for selecting a connection request type for use in contacting a managed device. ACS configuration module 465 and connection request type selection module 485 may be implemented in hardware, such as an ASIC, or as program instructions stored in memory device 460 and executed by processor 455. An ACS configuration database 470 is also shown. The ACS configuration database 470 may be stored, for example, in memory device 460. In a preferred embodiment, the ACS configuration database 470 stores configuration parameters associated with particular client devices. Similarly a connection request type database 475 preferably stores parameters related to various types of connection requests, and may be referred to when determining an appropriate connection request type and provisioning an ACS. Finally, network interface 480 is present to allow the external server 450 to communicate via a communications network such as the Internet (see, for example, FIG. 2).

FIG. 8 is a flow diagram illustrating a method 500 according to an embodiment of the present invention. At START it is presumed that the components necessary for execution of the process are available and configured to operate according to this embodiment (see, for example, FIG. 6). The process then begins when an ACS receives (step 505) an inform message from a managed client device. The ACS then determines (step 510) whether the client-device connection-request settings are configured. This may be done, for example, by reference to a CPE configuration database in or accessible to the ACS, or by querying the client device itself. If so, the process simply continues with whatever other actions, if any, need to be performed at this time with respect to the client device.

In this embodiment, if the client-device connection-request settings are not configured, the ACS fetches (step 515) the data model parameters from the client device for example using a GPV instruction. The ACS also sets (step 520) the inform message interval of the client device to send relatively frequent inform messages, for example one every five minutes. The ACS then notifies (step 525) an external server, providing information identifying the client device and the fetched parameters.

In the embodiment of FIG. 8, the ACS then receives (step 530) from the external server the parameters needed to configure the client device, and stores (step 535) them in the CPE configuration database. Note it is presumed here that the external server is successful in determining a connection request type and providing the necessary parameters. If adequate information is not received at step 530, then several options are available (not not shown in FIG. 8). For example, the ACS may simply send the notification to the external server again, either after a certain time period has passed, after being notified by the external server, or upon receiving the next inform message from the client device. The ACS may also set a flag in the CPE configuration database indicating that an unsuccessful attempt to obtain the necessary configuration parameters has been made. A notification to the network operator may also be generated.

Returning to the embodiment of FIG. 8, the ACS eventually receives (step 540) an inform message once the CPE configuration database has been populated with the necessary parameters. (Note that determining that the client device has not been configured but that the necessary parameters are now available can also be considered part of the determination of step 510. If the CPE is not configured bur configuration parameters are available, then the process skips to step 545.) The connection request mechanism on the client device can now be configured (step 545) by the ACS. Preferably, a flag is set (not separately shown) in the CPE configuration database indicating that the client device is now set to receive connection requests. It is also preferred that at this time the informal message interval is set (step 550) to a normal operational interval, for example twenty-four hours.

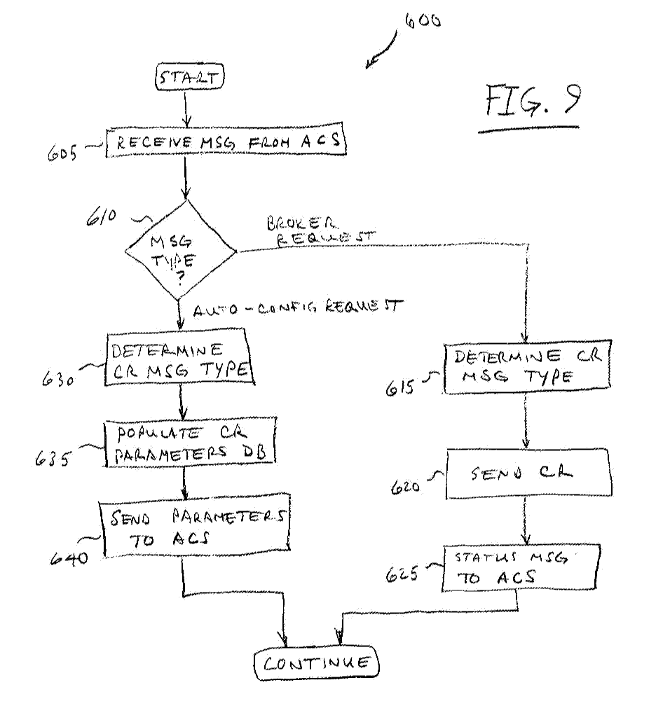

FIG. 9 is a flow diagram illustrating a method 600 according to an embodiment of the present invention. At START it is presumed that the components necessary for execution of the process are available and configured to operate according to this embodiment (see, for example, FIG. 7). The process then begins when the external server receives (step 605) a message containing the ID of a managed client device from an ACS. The external server then determines (step 610) the nature of the message received. If the message is a request that the external server initiate a communication session between the ACS and the client device, the external server examines any parameters included in the ACS message and determines (step 615) a type of connection request for use in contacting the client device.

In the embodiment of FIG. 8, the external server then sends (step 620) a connection request to the client device according to the determination made at step 615. When a response has been received from the client device (or a period of time has elapsed since sending the message), the external server sends (step 625) a message to the ACS indicating whether the attempted contact with the client device has been successful. Note that the external server may in some circumstances report a failure when the connection request has in fact been successfully received in the client device and acted upon. The ACS receiving the desired inform message may then simply disregard the notification from the external server (not shown).

In the embodiment of FIG. 9, if it is determined at step 610 that the ACS message indicates auto configuration of the client device, then the external server examines any parameters included in the ACS message and determines (step 630) a type of connection request for use in contacting the client device. This step may also include reference to a connection-request database (not separately shown in FIG. 9). In this embodiment, the external server then stores (step 635) the ID of the client device in a CPE parameters database in association with the parameters necessary for configuring the client device. The external server then sends (step 640) the parameters to the ACS so that the client device can be configured (not shown in FIG. 9) at the next opportunity. The process then continues with awaiting the next ACS communication.

Note that, as mentioned above, there may be more than one type of connection request suitable for prompting the client device to send an inform message or otherwise initiate a communication session with the ACS. In case the external server preferably selects the most appropriate.

Note that the sequence of operation illustrated in FIGS. 8 and 9 represent exemplary embodiments; some variation is possible within the spirit of the invention. For example, additional operations may be added to those shown in FIGS. 8 and 9, and in some implementations one or more of the illustrated operations may be omitted. In addition, the operations of the methods may be performed in any logically-consistent order unless a definite sequence is recited in a particular embodiment.

Although multiple embodiments of the present invention have been illustrated in the accompanying Drawings and described in the foregoing Detailed Description, it should be understood that the present invention is not limited to the disclosed embodiments, but is capable of numerous rearrangements, modifications and substitutions without departing from the invention as set forth and defined by the following claims.

1. A method for facilitating communication between a managing server and a managed client device, comprising:
receiving at an external server a notification from an ACS (auto configuration server) comprising the ID (identification) of a managed client device; and
determining at least one type of connection request message for sending a connection request to the client device.

2. The method of claim 1, further comprising sending the determined type of connection request to the client device.

3. The method of claim 2, further comprising sending a response to the ACS indicating that the connection request has been sent.

4. The method of claim 2, further comprising sending a response to the ACS indicating that the attempted connection request has failed.

5. The method of claim 1, wherein determining at least one type of connection request comprises referring to a device database associated with the external server.

6. The method of claim 1, wherein the notification from the ACS comprises data model parameters associated with the client device.

7. The method of claim 6, further comprising determining by the external server configuration parameters for configuring the client device.

8. The method of claim 7, further comprising sending the configuration parameters to the ACS.

9. The method of claim 8, further comprising configuring the client device during a communication session between the ACS and the client device.

10. The method of claim 6, further comprising determining by the ACS that the client device connection request parameters are not configured prior to sending the notification to the external server from the ACS.

11. An external server for facilitating communications between a managing server and a managed client device, comprising:
a processor;
a memory device in communication with the processor; and
a connection request type selection module for selecting a connection request type for associating with a client device.

12. The external server of claim 11, further comprising an ACS (auto configuration server) configuration module for provisioning an ACS with parameters associated with a selected connection request type.

13. The external server of claim 11, further comprising a CPE (customer premises device) type database on the memory device for storing available types of connection requests.

14. The external server of claim 11 further comprising a CPE parameters database for storing the parameters associated with an available connection request type.

15. The external server of claim 11 further comprising program instructions stored on the memory device that when executed send a connection request to the client device.

16. An ACS for facilitating communications between a managing server and a managed client device, comprising:
a processor;
a memory device in communication with the processor embodying program instructions that when executed cause the ACS to send a message to an external server requesting that the external server broker initiating a communication session between the ACS and a client device identified in the message.

17. The ACS of claim 16, wherein the program instructions further cause the ACS to send a message to an external server to request configuration parameters for configuring the client device to respond to a connection request from the external server.

18. The ACS of claim 16, further comprising a CPE configuration module for configuring a client device with parameters received from the external server and associated with the client device.
